(19) United States
(12) Patent Application Publication
(10) Pub. No.: US 2009/0141737 A1
(43) Pub. Date: Jun. 4, 2009

(54) SYSTEMS AND METHODS FOR PRIORITIZED CHANNEL ACCESS HARDWARE ASSISTANCE DESIGN

(75) Inventor: Jin-Meng HO, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/947,853

(22) Filed: Nov. 30, 2007

(51) Int. Cl. H04L 12/413

(52) U.S. Cl. 370/447

(57) ABSTRACT

Systems, networks and methods are provided that are operable for network communication among devices that have a medium access control (MAC) sublayer operable to build and forward at least a frame for network communication, a physical (PHY) layer operable to transmit at least a frame received from the MAC sublayer, and a prioritized, contention-based channel access mechanism (PCA) coupled to the MAC sublayer and having contention access logic for assessing whether a frame transmission may commence and an interrupt service routine for initiating transmission by the PCA of the at least a frame.

### BACKGROUND

Networks communicate information in the form of computer data, voice, video, etc. among devices by using a transmission medium. Such medium may be a wired link, an optical link (e.g., fiber optic), a wireless link including, but not limited to, radio frequency (RF), infrared, laser, microwave, etc., or a combination of different links. It has become increasingly popular and efficient to use a shared (rather than dedicated) transmission medium to communicate the information. Examples of shared transmission media include Ethernet, token ring, wireless Ethernet (IEEE 802.11), ultra wide band (UWB), etc.

Given the rise in mobility and devices becoming increasingly interoperable, networks may be more than the customary established grouping of devices. Instead, or in some cases in addition, devices join and leave networks on an ad hoc basis. Such devices may join an existing network, or may form a temporary network for a limited duration or for a limited purpose. An example of such networks might be a personal area network (PAN). A PAN is a network used for communication among computer devices (including mobile devices such as laptops, mobile telephones, game consoles, digital cameras, and personal digital assistants) which are proximately close to one person. The devices may or may not belong to the person in question. The reach of a PAN is typically a few meters. PANs can be used for communication among the personal devices themselves (ad hoc communication), or for connecting to a higher level network and/or the Internet (infrastructure communication). Personal area networks may be wired, e.g., a universal serial bus (USB) and/or IEEE 1394 interface or wireless. The latter “connects” via network technologies consistent with the protocol standards propounded by the Infrared Data Association (IrDA), the Bluetooth Special Interest Group (Bluetooth), the WiMedia Alliance's ultra wideband (UWB), or the like.

Complementary to the IEEE 802.11 wireless local area network (LAN) standard, the WiMedia Alliance, Inc. has defined a standard (hereinafter the “WiMedia standard”) for a distributed medium access control (MAC) sublayer for wireless networks, where the MAC sublayer corresponds to that of the standard ISO/OSI-IEEE 802 reference model. (WiMedia Alliance, Release 1.01, Dec. 15, 2006). ECMA-368 and ECMA-369 are international ISO-based specifications for the WiMedia ultra-wideband (UWB) common radio platform. In the WiMedia standard, the MAC sublayer provides, among other functionalities, a prioritized, contention-based channel access mechanism, also sometimes referred to simply as a prioritized channel access or PCA, for communication among multiple devices sharing a transmission medium, and multiple “access categories” (AC) within each device, to contend for access to the channel (wireless medium). The PCA requires each device to monitor the state of the channel for a certain specified duration (the duration being probabilistically different for each device and each access category) to assess whether the transmission channel is busy or idle. If the channel is determined to be idle for this duration, the device is permitted a specified interval within which to turn from receive mode to transmit mode and thereafter begin transmitting.

As is appreciated by those skilled in the art, it is exceedingly difficult for a device to accomplish all of the activities and functions necessary to turn from listening (i.e., receive mode) to transmitting within the duration of the specified interval. For example, the device must determine the winning access category including the data rate at which to transmit, fetch transmit data for that access category, start transmitting, etc.—all entirely within that interval. Thus, a need has arisen for a mechanism for more efficiently accomplishing the turnaround from receive to transmit modes.

### BRIEF DESCRIPTION OF THE DRAWINGS

For a detailed description of exemplary embodiments of the invention, reference will be made to the accompanying drawings in which:

FIG. 1 illustrates a block diagram of an exemplary architecture 10 in which embodiments may be implemented to advantage;

FIG. 2 illustrates an exemplary superframe suitable during which to implement embodiments of the disclosure;

FIG. 3 illustrates a transmission chart of timing for a contention-based transmission where at least one of the embodiments presently disclosed for increasing the efficiency of processing MAC may be implemented to advantage;

FIG. 4 illustrates an exemplary superframe, together with the corresponding functionality flow, within which embodiments operate;

FIG. 5 illustrates a contention-based transmission protocol flow in accordance with embodiments;

FIG. 6 illustrates an overall timing control arrangement for an embodiment of a medium access control (MAC);

FIG. 7 depicts a block diagram illustrating a state machine in accordance with embodiments;

FIG. 8 illustrates an exemplary embedded or general-purpose computer system suitable for implementing the several embodiments of the disclosure; and

FIG. 9 illustrates a block diagram of an exemplary wireless network, comprising a pair of wireless devices each with exemplary MAC, PHY, and MAC-PHY interface suitable for implementing the several embodiments of the disclosure.

### NOTATION AND NOMENCLATURE

Certain terms are used throughout the following description and claims to refer to particular system components. As one skilled in the art will appreciate, computer companies may refer to a component by different names. This document doe not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “frame” refers to a basic communication structure which includes overhead information and data information.

### DETAILED DESCRIPTION

It should be understood at the outset that although an exemplary implementation of one embodiment of the disclosure is illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the disclosure implement improvements to the PCA of a MAC sublayer so that a device can more quickly turn from listen mode to transmit mode, and with reduced complexity. Embodiments decrease the inter-frame time required by a device to make the transition from reception (Rx) to transmission (Tx) which, in turn, increases the time available to prepare the frame for transmission. Embodiments may be used in any wireless transmission including, but not limited to, WiMedia Ultra-Wideband (UWB) communication, WiMedia communication, or any other network communication using the MAC layer as disclosed herein. In addition, embodiments may also be used in wired communications, including, but not limited to IEEE 1394, Ethernet, and other wired communications. Moreover, implementing embodiment features in 802.11-compliant devices requires various modifications of the MAC and PHY layers, as well as their interactions, from the currently adopted 802.11 standard. These variations have been implemented in the following discussion and associated figures. It should be understood, however, that the scope of this disclosure and the claims that follow need not be limited to the 802.11 context.

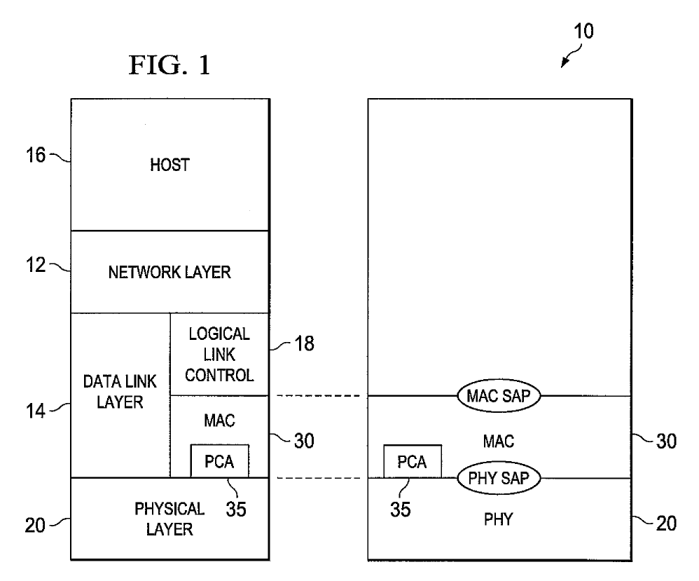

FIG. 1 illustrates a block diagram of an exemplary architecture 10 in which embodiments may be implemented to advantage. As will be appreciated, the architecture 10 is divided into layers: network layer 12, data link layer 14, and physical layer (PHY) 20. Among other capabilities, PHY layer 20 transmits frames from a source device (e.g., host 16) to a destination device. Additionally, PHY layer 20 assesses the medium to ascertain whether the communication channel is idle or busy. Network layer 12 enables the host 16 to interface with data link layer 14. Data link layer 14 comprises logical link control sublayer 18 and medium access control (MAC) sublayer 30. MAC 30 communicates with logical link control 18 and separately with PHY 20 using dedicated service access points (SAPs).

Frame transmission and reception are supported by the exchange of parameters between the MAC sublayer 30 and the PHY layer 20. These parameters enable MAC sublayer 30 (sometimes referred to herein as MAC 30) to control, and be informed of, the frame transmission mode, the frame payload data rate and length, the frame preamble, the PHY channel and other PHY-related parameters. Embodiments of MAC 30 have a variety of capabilities, including but not limited to, a distributed, reservation-based channel access mechanism known as the distributed reservation protocol (DRP); a prioritized, contention-based channel access mechanism (i.e., PCA); mechanisms for handling mobility and interference situations, device power management, frame transmission and reception scheduling, security (e.g., encryption), etc.

It will be appreciated that in some embodiments, MAC 30 for each MAC client (e.g., host device 16) work together to provide these functions; no device acts as a central coordinator. As a result, when devices communicate, collisions may occur during competing transmissions. As one way to resolve these collisions, MAC 30 comprises a prioritized, contention-based channel access mechanism (PCA) 35.

Coordination of devices within range is achieved by the exchange of beacon frames, also known as beacons. Periodic beacon transmission enables device discovery, supports dynamic network organization, and supports mobility. Beacons provide the basic timing for the network and carry reservation and scheduling information for accessing the medium. Information included in beacon frames facilitate contention-free frame exchanges by ensuring that a device does not transmit frames while a neighboring device is transmitting or receiving frames.

The basic timing structure for frame exchange is a superframe (SF). The superframe duration is predetermined, e.g., 65.536 μs. The superframe is composed of medium access slots (MASs); in some embodiments there are 256 such slots per superframe. Each superframe starts with a beacon period (BP), which extends over one or more contiguous MASs, followed by a data period.

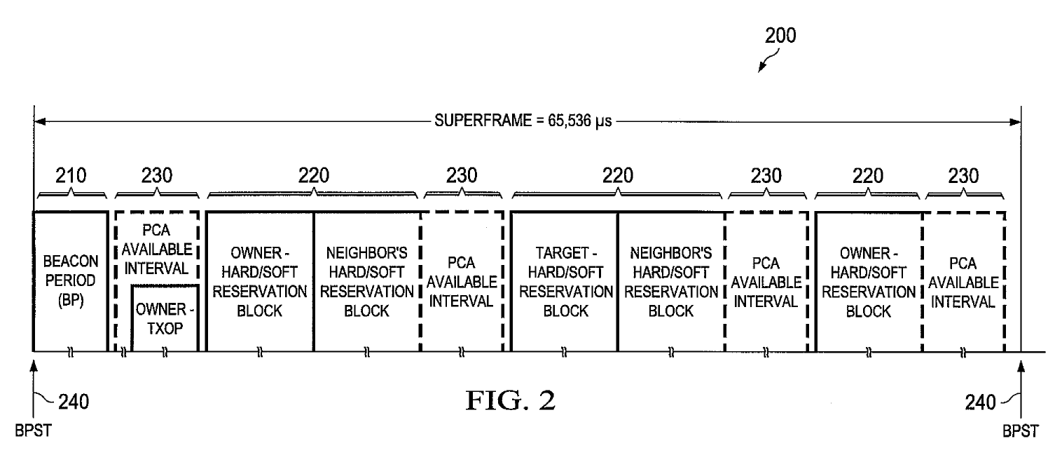

In some embodiments, and as seen in FIG. 2, there are three types of access intervals in each superframe 200, a beacon period 210, at least one reservation block 220 and at least one PCA available interval 230. Each superframe 200 starts with a BP 210, which extends over one or more contiguous MASs. The start of the first MAS in the BP 210, and the superframe 200, is called the beacon period start time (BPST) 240. A beacon period (BP) 210 is for beacon transmission and reception, i.e., for devices to synchronize their superframes, announce their presence, announce other managerial activities (e.g., an intent to hibernate or cease reception for a defined period of time), etc. Consistent with the WiMedia technical specifications, provisions for both contention-free and contention-based communications are provided in separate communication intervals within superframe 200. A reservation block 220 is used for contention-free data transfer from reservation owner to reservation target(s) and acknowledgment back from the target(s) to the owner. A “neighbor” refers to a device within range of a subject device or owner, and may or may not be the intended recipient or target of a transmission. A PCA available interval 230 is essentially any time remaining in a superframe 200 which is not a beacon period 210 or a reservation block 220. A PCA available interval 230 is used by network devices for contention transfers from a transmit opportunity (TXOP) owner to any target. During contention communications, each device with data to transmit must content with other devices for access to the communications medium. A source device obtains a TXOP and becomes a TXOP owner within a PCA available interval 230 when its backoff counter is zero (0). It will be appreciated that the superframe 200 illustrated in FIG. 2 is strictly exemplary; the number of and relative durations of reservation blocks 220 and PCA available intervals 230 may vary among superframes.

As will be readily apparent, with such a communication arrangement, collisions would be likely without a dynamic MAC 30 orchestrating behavior among the devices in any given network. Please recall that the network itself may be dynamic with devices joining and leaving the network ad hoc, as would be the case with a personal area network (PAN) or a distributed network, especially one comprising at least one mobile device.

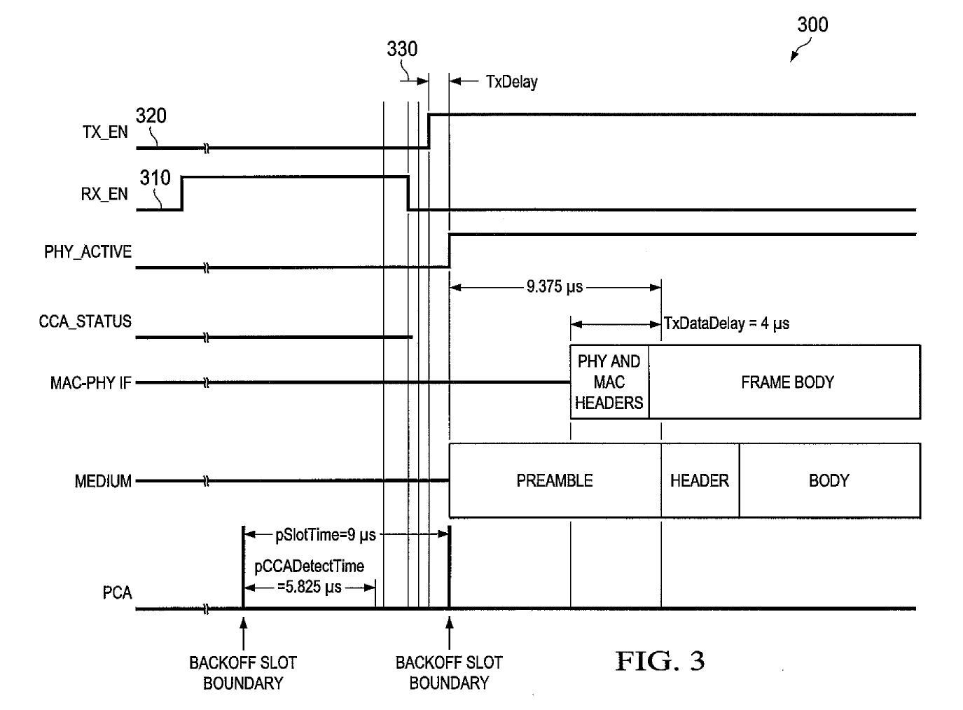

FIG. 3 illustrates one embodiment of a data transmission chart 300 of timing for a contention-based transmission where at least one of the embodiments presently disclosed for increasing the effective processing time for MAC 30 may be implemented to advantage. In this example embodiment, the focus is on the timing for a PCA-initiated transmission. At pCCADetectTime from the start of a backoff slot (e.g., 5.825 μs in the illustrated example), MAC 30 checks for a clear channel assessment status (labeled in example as “CCA_STATUS”) signal provided by the PHY 20. Here, pCCADetectTime is the amount of time MAC 30 takes to determine whether the medium is idle during a backoff slot (also termed PCA slot) of length pSlotTime (which is 9 μs in the illustrated example). If the CCA_STATUS signal is low, indicating an idle medium status, MAC 30 decrements a backoff counter by one. When the backoff counter reaches zero, MAC 30 instructs PHY 20 to start transmitting the preamble of a frame at the end of the current backoff slot. To this end, MAC 30 deasserts RX_EN 310 which was asserted to receive potential frames, and then asserts TX_EN 320 such that by a transmit delay (TxDelay) 330 interval later, PHY 20 (labeled, for example, in FIG. 3 as “PHY_ACTIVE”) starts the preamble transmission over the air (labeled, for example, in FIG. 3 as “MEDIUM”) at the time when the current backoff slot ends. As can be seen, MAC 30 has the header ready for PHY 20 within the transmit data delay (TxDataDelay) of the end of the preamble on the air (medium). TxDataDelay is the time interval from when the PHY is able to start requesting data from the MAC over the MAC-PHY interface (“MAC-PHY IF”) to when the transmission of the preamble over the air ends. As is apparent, the turn-around time from listening (RX) to transmitting (TX) is extremely short.

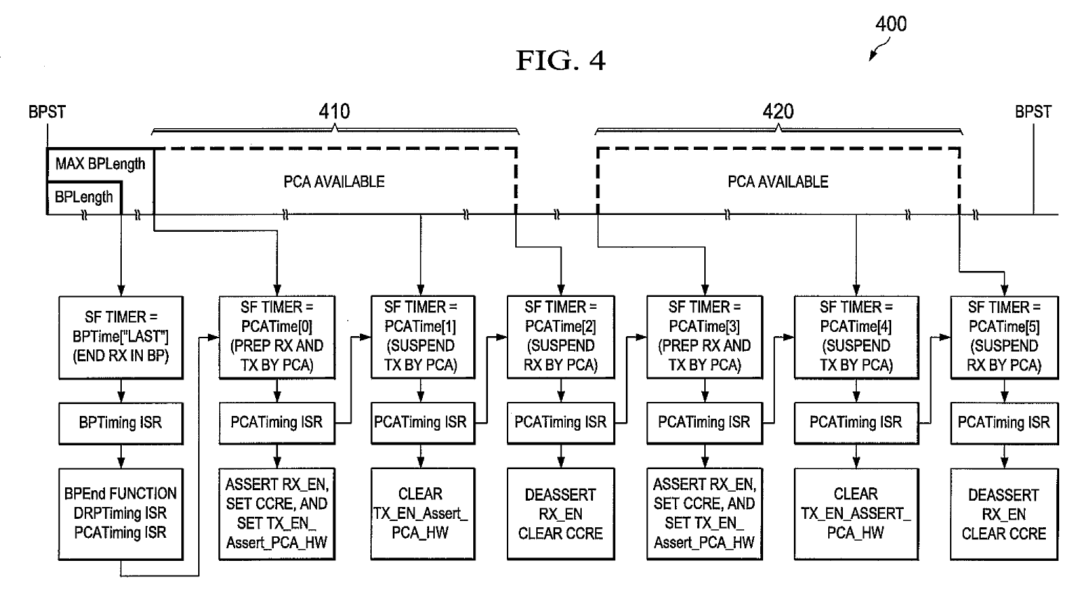

FIG. 4 illustrates—for simplicity's sake—a superframe 400 with the beacon period and two PCA available intervals, together with the corresponding functionality flow of at least one embodiment. At the end of superframe 400, a new beacon period start time occurs indicating that a new superframe 400 has begun. In embodiments of the disclosure, MAC 30 determines whether to initiate at least one transmission (each transmission variably predetermined N slots in duration) within a particular PCA available interval (designated 410 and 420 in the present example). This is accomplished in embodiments as follows.

Starting at the trailing edge of the permitted transmission time within the beacon period, also referred to as an announced beacon period length (which is preferably not longer than a predetermined maximum beacon period length, and is often some predetermined time prior to the end of the maximum beacon period length), the MAC superframe timer signals the end of the time during which a device might receive further scheduling and managerial information from other device(s) on the network. A beacon period timing interrupt service routine (BPTiming ISR) is triggered, which in turn begins the clean up work corresponding to assimilating information received during the beacon period, and closing down beacon period aspects of its reception (listening; RX) function. At the end of the beacon period, BPTiming ISR launches both the DRP and PCA Timing ISRs, which ISRs are coordinated based on the information, if any, received from other device(s) during the beacon period. DRPTiming ISR tracks whether to prepare reception (RX) or transmission (TX) by PCA, to suspend TX by PCA and/or to suspend RX by PCA. PCATiming ISR determines whether there is sufficient time in the present PCA available interval (interval 410 in this discussion) to complete a frame transaction.

For PCA 35 of MAC 30 to decide that there is sufficient time, there must be enough time within the current PCA available interval to set up and transmit a frame from the TXOP owner device, as well as receive an acknowledgment from the target device, all of which is considered a frame transaction. However, within a TXOP, timings are controlled and/or triggered by preceding TX/RX events. This dynamic situation is what contributes to increased collisions on the medium—and what embodiments of the disclosure greatly reduce or ameliorate by providing more flexibility and responsiveness to the system. Assuming PCA 35 of MAC 30 determines there is sufficient time in the upcoming (present) PCA available interval 410 to complete a frame transaction, MAC 30 determines whether the medium is idle. Thus, before its transmission can begin, for example, MAC 30 asserts the listening function (assert RX_EN in FIG. 4), and sets the CCRE. The CCRE is a CCA request to the PHY layer 20 for starting CCA estimation, where CCA is the clear channel assessment, i.e., an assessment of whether the channel is currently clear (idle) or not busy.

If there is still sufficient time between when the medium is determined clear and the predetermined end of interval 410, MAC 30 sets TX_EN_Assert_PCA_HW register. However, if the interval is particularly small—again remember, despite how intervals 410 and 420 are portrayed in FIG. 4, PCA available intervals vary in length depending upon available channel time between scheduled or reserved (DRP) intervals—there might not still remain enough time in PCA available interval 410 for MAC 30 to complete a frame transaction or, alternatively, to complete another frame transaction. Once the superframe timer reaches the time beyond which there will no longer be sufficient time to complete a frame transaction, PCATiming ISR clears TX_EN_Assert_PCA_HW register to suspend transmission (TX) by PCA. At the trailing edge of interval 410, the PCATiming ISR suspends listening for medium availability by PCA 35 (deasserts RX_EN and clears CCRE).

Upon the beginning of the next PCA available interval, identified as 420 in FIG. 4, the MAC 30 will again determine whether to initiate at least one transmission within that particular PCA available interval by PCA. This process repeats for every PCA available interval in superframe 400.

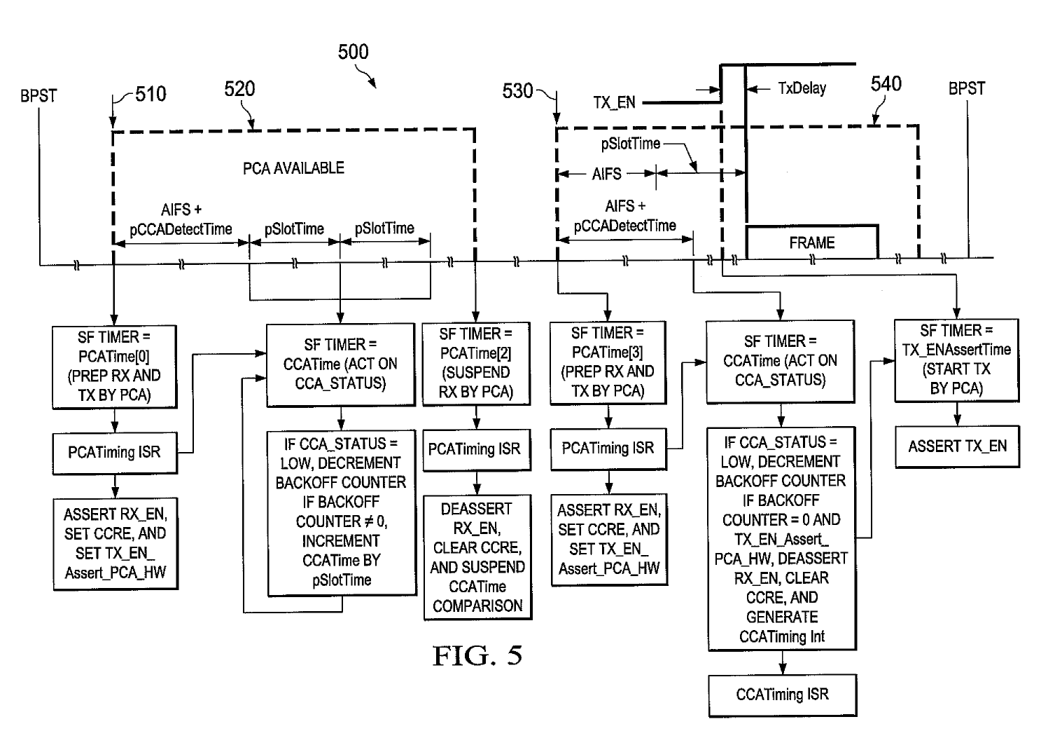

FIG. 5 is an embodiment of a contention-based transmission protocol flow 500. At a predetermined time following the beacon period, the medium becomes available for PCA. At the leading edge 510 of PCA available interval 520, the superframe (SF) timer signals that it is time for the PCA to begin preparing for reception or transmission. At that time, an interrupt causes a PCATiming interrupt service routine (ISR) to prepare to determine whether the medium continues to be idle. To that end, and as described in connection with FIG. 4, the PCATiming ISR asserts RX_EN, sets the CCRE, and sets the TX_EN_Assert_PCA_HW. The PCATiming ISR also determines a value equal to the duration of the arbitration inter-frame space (AIFS) plus the time (pCCADetectTime) it will take to determine that the medium is idle in the current backoff slot, and loads a time corresponding to that value into a CCATime register. AIFS is the minimum time that a device using PCA defers access to the medium after it determines the medium to have become idle.

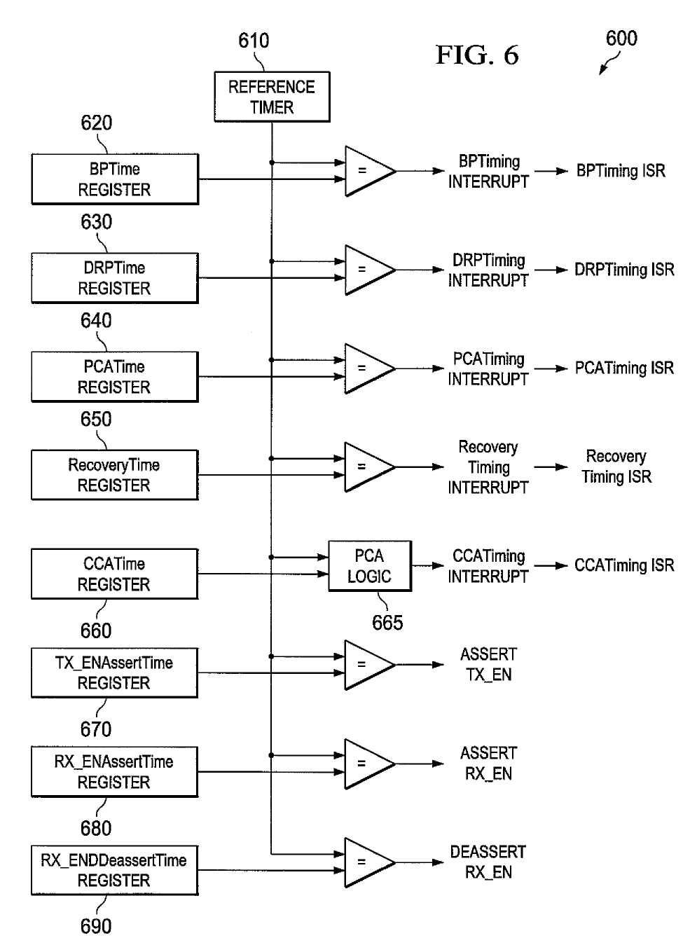

To better understand the flow of FIG. 5, turn momentarily to FIG. 6, which is an illustration of an overall timing control arrangement 600 for an embodiment of a medium access control (MAC). Specifically, reference or protocol timer 610 is compared with the contents of various registers; when a comparison of the timer with the contents of a register is true (equal), then the interrupt routine corresponding to that register is initiated. When the value in beacon period time register 620 equals the value of reference timer 610, a BPTiming interrupt is triggered, launching a BP Timing ISR. When the value in the distributed reservation protocol (DRP) time register 630 equals the value of reference timer 610, a DRPTiming interrupt is triggered, launching a DRP Timing ISR. Similarly, when the value of prioritized contention access (PCA) time register 640 equals the value of reference time 610, a PCATiming interrupt results, launching in turn a PCA Timing ISR. Thus, the equivalence of values between reference timer 610 and recovery time register 650 triggers a RecoveryTiming interrupt resulting in the initiation of a Recovery Timing ISR; and equivalence of values between reference timer 610 and clear channel assessment (CCA) time register 660, via PCA logic 665, triggers a CCATiming interrupt resulting in the launch of a CCA Timing ISR. It will be appreciated that, although it is preferred that PCA logic 665 is hardware, in some embodiments PCA logic 665 may instead be implemented entirely in firmware, or implemented as a combination of hardware and firmware.

Equivalence of values between reference timer 610 and transmission enable (TX_EN) assert time register 670 results in the assertion of transmission enable circuitry. The circuitry to assert or deassert reception is triggered by the equivalence with the value in the reception enable (RX-EN) assert time register 680 or the RX_EN deassert time register 690, respectively, when compared with the reference timer 610. It will be appreciated that any comparison made (typically by a comparator, or other comparison circuitry, or comparison mechanism comprising a combination of hardware and software, etc.) is preferably activated following a write to the corresponding time register to avoid invalid comparison with an old value in that register.

In at least one embodiment, each of the registers is readable/writable by various routines or instructions of the MAC; in other embodiments, at least some of the registers are readable and/or writable by hardware; in further embodiments, the registers are readable and/or writable by a combination of hardware and firmware. It will be appreciated that other combinations are possible. In at least some of the embodiments, each register is 19 bits in length. In some embodiments, the unit of the registers and timer is ⅛ microsecond. Regardless of the value of the unit employed, the value in the register or the reference timer (at a given instant) indicates a time equal to that value multiplied by the unit (⅛ μs, in this example).

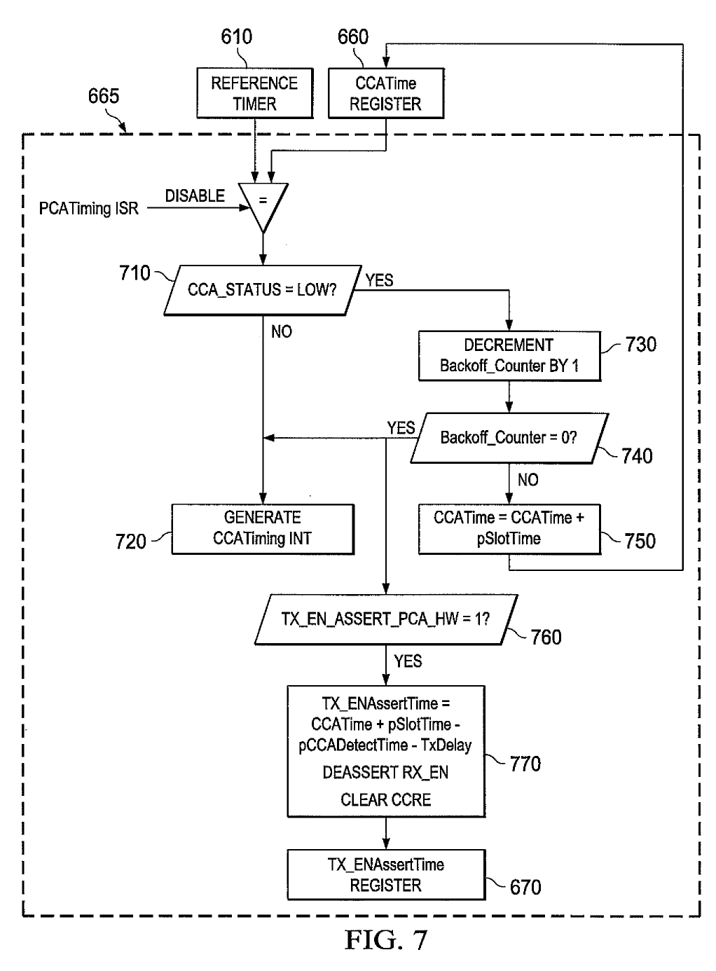

Before returning to FIG. 5, turn to FIG. 7, which provides greater detail of an embodiment of PCA logic circuitry 665, and is an illustration of a state machine 665 corresponding to such embodiment. PCA logic 665 may also be alternatively referred to as PCA logic circuitry 665 or state machine 665 in this disclosure. Assuming the comparator has not been disabled by the PCATiming ISR, reference timer 610 is compared with the contents of CCATime register 660 to determine whether the CCA_STATUS is low, indicating that the medium is idle or available (block 710). Assuming it is determined that the medium is not idle (i.e., it is busy), the state machine generates a CCATiming interrupt (block 720), which triggers a CCATiming ISR to do certain bookkeeping jobs on PCA state variables, such as the backoff counter, in preparation for the next PCA available interval. If, however, it is determined at block 710 that the medium is indeed idle, then the backoff counter is decremented by one (1) at block 730. A determination is made at block 740 whether the backoff counter is now equal to zero (0). If the backoff counter is not reflecting a zero value, then the CCATime is incremented by the value of pSlotTime (block 750) which is the length of a backoff slot, and state machine 665 loads that incremented value into the CCATime register 660 for the next comparison iteration with reference timer 610. If, however, backoff counter is reflecting a zero value, then state machine 665 determines at block 760 whether TX_EN_Assert_PCA_HW is set to high (or “1”). If it is not set to high, then there is insufficient time to transmit, and the transmission function by PCA is suspended. If, however, it is set to high, then at block 770 the listening circuitry is deasserted, the CCRE is cleared, and TX_ENAssertTime is set equal to the next backoff slot start time, and preparation begins for transmission. Thus, TX_ENAssertTime is set equal to CCATime+pSlotTime−pCCADetectTime−Txdelay, or in other words, the beginning of transmission is set to the value in the CCATime register plus the duration of the slot, less the time it takes to detect whether the medium is still idle, less the time it takes to power up the PHY to transmit. This value is loaded into the TX_ENAssertTime register (block 670).

Returning now to FIG. 5, when the SF timer equals the value in the CCA time register, indicating that the PCA must act based on the value stored in the CCA_STATUS register, PCA logic 665 begins to function. At this time, PCA logic 665 checks the CCA status register. If the CCA_Status is low, i.e., the medium is idle, the backoff counter is decremented. PCA logic 665 then checks the value of the backoff counter. If the backoff counter value does not equal zero, the CCATime register is preferably incremented by one pSlotTime. The SF timer is again compared to the CCATime, and, assuming there is still sufficient time remaining in the present PCA available interval 520 to permit a complete frame transaction, this comparison and decrementing continues until the backoff counter equals zero or the PCA available interval ends. However, in this example, there is not sufficient time. Thus, and as was also described with respect to FIG. 4, once SF timer equals the predetermined value which corresponds to the falling edge of PCA available interval 520 in this example (designated as PCATime[2] in FIG. 5), then transmission and reception by PCA are suspended. At this time, an interrupt launches the PCATiming ISR which in turn deasserts RX_EN, clears CCRE, and suspends the CCATime comparison, thereby saving power by shutting down portions of PCA 35 when they are no longer needed.

At the beginning or leading edge 530 of the next PCA available interval 540, PCA 35 again begins preparations to receive or transmit. As before, an interrupt launches the PCATiming ISR to assert the RX_EN and set the CCRE, to thereby determine (by listening) whether the medium is idle. PCATiming ISR also programs the CCA time register as described earlier and sets the transmission hardware (designated as TX_E_Assert_PCA_HW) in preparation for possible transmission. When the SF timer equals the value in the CCA time register, indicating that the PCA must act based on the value stored in the CCA_STATUS register, PCA logic 665 begins to function again. At this time, PCA logic 665 checks the CCA status register. If the CCA_Status is low, i.e., the medium is idle, the backoff counter is decremented. PCA logic 665 then checks the value of the backoff counter. This time, in this example, backoff counter value equals zero (0). As a result, PCA logic 665 checks to see whether the transmission hardware was set, deasserts the function of checking whether the medium is idle (deassert RX_EN and clear any CCRE), and generates an interrupt which launches the CCATiming ISR. The CCATiming ISR prepares the frame for transmission to PHY 20.

State machine 665 also determines the value of the TX_ENAssertTime and loads it into a register. This value is determined by adding the value of leading edge 530 of PCA available interval 540 to AIFS plus pSlotTime−TxDelay. When the SF timer equals the value of TX_ENAssertTime, an interrupt occurs, thereby signaling to start transmission by PCA 35. This comparison results in PCA 35 powering up the PHY for transmission (assert TX_EN). Transmission to PHY 20 of the prepared frame is facilitated by CCATiming ISR.

By having PCA logic 665 perform most, if not all of the transmission-related condition/decision functions, PCA 35 of MAC 30 gains significant critical timing budget for building the elements of the frame to be transmitted to PHY 20. For example, with PCA logic 665, the CCATiming ISR does not need to check the CCA_STATUS register, deassert the listening hardware, or assert the transmission hardware. This means that MAC 30 can more nimbly turn from reception mode to transmission mode because the CCA Timing ISR can focus on moving the header data to the MAC-PHY interface, while PCA logic 665 handles the condition/decision functions. Further to this example, with PCA logic 665 support, CCATiming ISR has about 8 μs to complete moving the header data to the MAC-PHY interface (see FIG. 3). However, without PCA logic 665 support, CCATiming ISR must check the CCA_STATUS register, deassert RX_EN, and assert TX_EN in less than 3 μs (see FIG. 3) taking into account the transmission equipment (e.g., radio) power-up delay. Embodiments of the disclosure also achieve some power and processing bandwidth savings because the CCATiming ISR is not active except when a transmission is going to occur. By employing at least one disclosed embodiment, MAC 30 is provided more time to prepare for data transmission; architectural flexibility is thereby increased as timing requirements are decreased. These embodiments may be used in any type of data communication in which MAC and PHY layers are present.

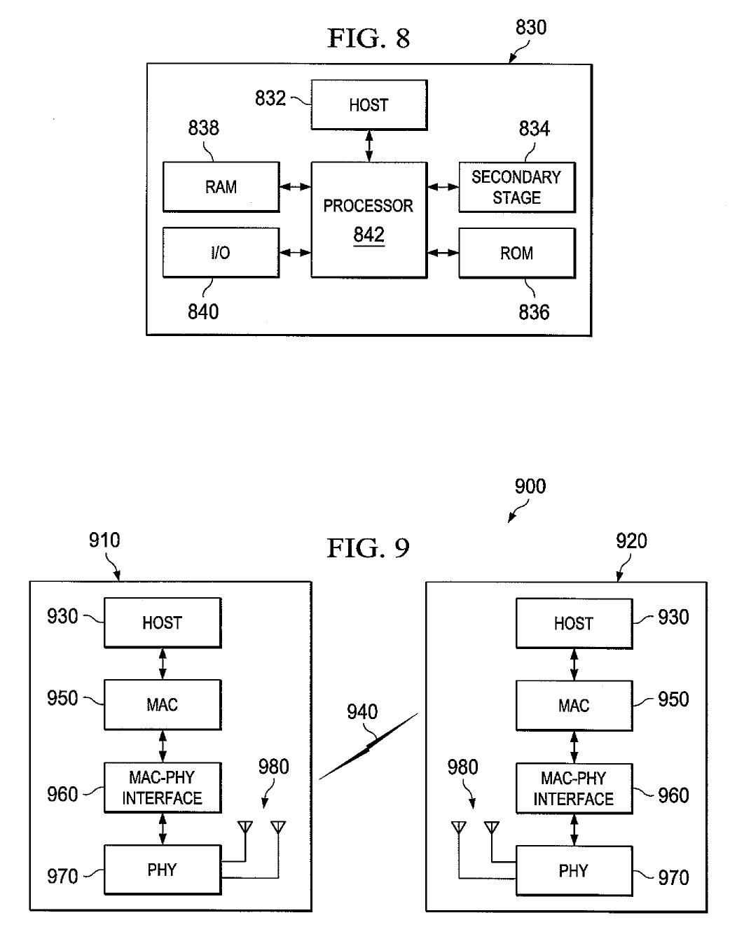

The systems and methods described above may be implemented on any embedded or general-purpose computer with sufficient processing power, memory resources, and network throughput capability to handle the necessary workload placed upon it. FIG. 8 illustrates a typical, embedded or general-purpose computer system suitable for implementing one or more embodiments of a system to respond to signals as disclosed herein. The computer system 830 comprises a processor 842 (which may be referred to as a central processor unit or CPU) that is in communication with memory devices including but not limited to secondary storage 834, read only memory (ROM) 836, random access memory (RAM) 838, input/output (I/O) devices 840, and host 832. The processor may be implemented as at least one CPU chip.

Secondary storage 834 is typically comprised of at least one disk drive or tape drive and is used for non-volatile storage of data and as an over-flow data storage device if RAM 838 is not large enough to hold all working data. Secondary storage 834 may be used to store programs that are loaded into RAM 838 when such programs are selected for execution. ROM 836 is a non-volatile memory device that typically has a small memory capacity relative to the larger memory capacity of secondary storage. RAM 838 is used to store volatile data and perhaps to store instructions. Access to both ROM 836 and RAM 838 is typically faster than to secondary storage 834.

I/O 840 may comprise printers, video monitors, liquid crystal displays (LCDs), touch screen displays, keyboards, keypads, switches, dials, mice, trackballs, voice recognizers, card readers, paper tape readers, or other well-known input devices. Host 832 may interface to Ethernet cards, universal serial bus (USB), token ring cards, fiber distributed data interface (FDDI) cards, local area network (WLAN) cards, and other well-known network devices. This host 132 may enable the processor 842 to communicate with an Internet and/or one or more intranets. With such a network connection, it is contemplated that the processor 842 might receive information from the network, or might output information to the network according to the above-described method.

The processor 842 executes instructions, codes, computer programs, scripts which it accesses from hard disk, floppy disk, optical disk (these various disk based systems may all be considered secondary storage 834), ROM 836, RAM 838, or the host 832.

The systems and methods described above may be implemented on devices with a MAC and a PHY. FIG. 9 illustrates an exemplary network 900 comprising a pair of wireless devices 910 and 920. Although only two devices are shown in wireless network 900, it should be understood that the network can comprise more than two devices, and that such network may have any number of devices joining and/or leaving on an ad hoc basis. Each device 910, 920 comprises host 930 (e.g., network computer, handheld computer, personal display assistant, etc.) which communicates with other devices(s) via wireless medium 940 using a MAC sublayer 950 and a PHY layer 970. The MAC sublayer 950 provides a variety of functions (e.g., data frame transmission, reception, security, etc.) and serves to facilitate effective wireless communications between devices. Host 930 uses these services to effectuate communications across wireless medium 940. PHY layer 970 provides an interface between MAC sublayer 950 and wireless medium 940 and, as such couples to at least one antenna 980. MAC and PHY layers are well known in the art and are described in greater detail in the IEEE 802.11 and WiMedia standards.

MAC 950 is capable, in this embodiment, of communicating with PHY 970 through MAC-PHY interface 960. MAC-PHY interface 960 may be a controller, processor, direct electrical connection, or any other system or method (that might be hardware, software or a combination thereof) which facilitates communication between MAC 950 and PHY 970. It is understood that MAC/PHY interface 960 may be implemented, for example and not by way of limitation, as an ultra-wide interface, a WiMedia interface, a wireless universal serial bus, a IEEE 1394 interface, and a wireless LAN interface. It is also expressly understood that MAC 950, MAC-PHY interface 960, and PHY 970 may be implemented on a single electrical device, such as an integrated controller, or through the use of multiple electrical devices. It is further contemplated that MAC 950, MAC-PHY interface 960 and PHY 970 may be implemented through firmware on an embedded processor, or otherwise through software on a general purpose CPU, or may be implemented as hardware through the use of dedicated components, or a combination of the above choices. Any implementation of a device consistent with this disclosure containing a MAC and PHY may contain a MAC-PHY interface. It is therefore expressly contemplated that the disclosed systems and methods may be used with any device with a MAC and a PHY.

It will be appreciated by those skilled in the art that the principles and various embodiments of the disclosure preferably use hardware and software or firmware working together so that each does what it does best. Hardware is used for tasks that it can perform quickly and efficiently (turnaround from receiving to transmitting) and for tasks that have very specific timing requirements (recurrently checking channel status). Firmware is used for decision-making and bookkeeping task such as determining the winning access category, deciding whether the device can transmit (based on other criteria) and selecting the actual data to transmit, as well as loading and updating backoff counter values.

It will further be appreciated by those skilled in the art that PCA logic or state machine 665 may be built using, for example, and not by way of limitation, a programmable logic device, a programmable logic controller, logic gates and flip flops or relays. A hardware implementation of PCA logic or state machine 665 employs at least one register to store state variables, a block of combinational logic which determines the state transition, and a block of combination logic that determines the output of PCA logic or state machine 665. It will also be appreciated by those skilled in the art that PCA logic or state machine 665 may alternatively be implemented in software using, for example, and not by way of limitation, an event driven finite state machine, a virtual finite state machine, automata-based programming, etc. Lastly, it will be appreciated by those skilled in the art that PCA logic or state machine 665 may alternatively be implemented in a combination of hardware and software or firmware.

The above discussion is meant to be illustrative of the principles and various embodiments of the disclosure. Numerous variations and modifications will become apparent to those skilled in the art once the above disclosure is fully appreciated. It is intended that the following claims be interpreted to embrace all such variations and modifications.

What is claimed is:

1. A system operable for network communication, comprising:
a prioritized, contention-based channel access mechanism (PCA) coupled to a medium access control (MAC) sublayer and comprising contention access logic for assessing whether a frame transmission may commence and an interrupt service routine for initiating transmission by the PCA of at least one frame.

2. The system of claim 1, wherein the contention access logic further comprises logic for assessing whether the transmission channel is currently clear.

3. The system of claim 2, wherein the logic for assessing further comprising logic for checking the contents of a clear channel register.

4. The system of claim 2, wherein the logic for assessing further comprising logic for communicating to the interrupt service routine the assessment that the transmission channel is currently not clear.

5. The system of claim 1, wherein the contention access logic further comprises logic for suspending reception mode.

6. The system of claim 5, wherein the logic for suspending further comprises logic for deasserting listening hardware and for clearing a clear channel request register.

7. The system of claim 1, wherein the contention access logic is at least partially software.

8. The system of claim 1, wherein the contention access logic further comprises logic for decrementing a backoff counter based on an assessment that the transmission channel is currently clear.

9. The system of claim 1, wherein the contention access logic further comprises logic for generating an interrupt to launch the interrupt service routine.

10. The system of claim 1, wherein the interrupt service routine further comprises instructions for initiating the transmission by the PCA based on a checking that the backoff counter currently has a zero value.

11. The system of claim 1, wherein the interrupt service routine comprises instructions for determining whether there is sufficient time remaining in a present contention interval to complete a frame transaction.

12. A system operable for network communication, comprising:
a medium access control (MAC) sublayer operable to build and forward at least a frame for network communication;
a prioritized, contention-based channel access mechanism (PCA) coupled to the MAC and comprising contention access logic for assessing whether a frame transmission may commence and an interrupt service routine for initiating transmission by the PCA of the at least a frame; and
a physical (PHY) layer operable to transmit at least a frame received from the MAC sublayer.

13. The system of claim 12, further comprising an interface operable to facilitate communication between the medium access control sublayer and the physical layer, wherein the interface is selected from the group of: a ultra-wide interface, a WiMedia interface, a wireless universal serial bus, a IEEE 1394 interface, and a wireless LAN interface.

14. A method for providing controlled frame transmission during a contention period in a shared communications medium comprising:
determining, by contention access logic, whether a frame transmission may commence;
if the shared communications medium is idle, initiating, by an interrupt service routine, a prioritized contention access transmission of at least a frame from a medium access control (MAC) sublayer to a physical (PHY) layer; and
transmitting, by the PHY layer, the at least a frame received from the MAC sublayer onto the communications medium.

15. The method of claim 14, wherein the transmitting comprises transmitting the at least a frame to a device.

16. The method of claim 14, wherein the transmitting comprises transmitting to a plurality of devices.

17. The method of claim 14, further comprising receiving, by the MAC sublayer, notification from a host that transmission of at least one frame is sought.

18. The method of claim 14, wherein the determining comprises monitoring the state of the shared communications medium for a certain specified duration.

19. A network, comprising:
at least two devices, each of which comprises
a host;
a medium access control (MAC) sublayer coupled to the host and operable to build and forward at least a frame for network communication;
a prioritized, contention-based channel access mechanism (PCA) coupled to the MAC and comprising contention access logic for assessing whether a frame transmission may commence and an interrupt service routine for initiating transmission by the PCA of the at least a frame; and
a physical (PHY) layer coupled to said MAC sublayer; wherein said PHY layer is operable to transmit at least a frame received from the MAC sublayer.

20. The network of claim 19, wherein the devices are wireless devices.

21. The network of claim 19, wherein the network is a wireless network.

22. The network of claim 19, wherein the interrupt service routine comprises instructions for determining whether there is sufficient time remaining in a present contention interval to complete a frame transaction.

23. The network of claim 19, wherein the contention access logic further comprises logic for suspending reception.

24. The network of claim 23, wherein the logic for suspending further comprises logic for deasserting reception mode and for clearing a clear channel request register.
